(19) United States
(12) Patent Application Publication
(10) Pub. No.: US 2023/0019939 A1
(43) Pub. Date: Jan. 19, 2023

(54) SYSTEM AND METHOD FOR MERGING A TWO OR MORE MULTI-LEVEL MARKETING SYSTEM INTO A MULTI-LINE MULTI-LEVEL MARKETING SYSTEM AND INTEGRATING A PRODUCT TREE MLM

(71) Applicant: KwikClick, LLC, Murray, UT (US)

(72) Inventor: Fred Cooper, Farmington, UT (US)

(21) Appl. No.: 17/863,192

(22) Filed: Jul. 12, 2022

Related U.S. Application Data
(60) Provisional application No. 63/220,855, filed on Jul. 12, 2021.

(51) Int. Cl. G06Q 30/02

(52) U.S. Cl. CPC G06Q 30/0214

(57) ABSTRACT

*Disclosed herein is a system and method to any two or more MLMs to be merged into a multiline MLM system despite having different commission structures. Each member of the original MLMs is able to maintain their existing downlines without any changes. Further the existing MLM members have full access to the multi-line MLM commission structure, for example, a member of a binary MLM may now add a 3rd, 4th, 5th, etc. line if they choose. The multiline commission plan will be different than the commission plans from any of the original MLMs but this change should not affect the income of a large portion of users, and users that are affected by the changeover can be compensated or made whole on an individual level. In addition to this multiline commission plan, the commission structure of the original MLMs has been broken into several separate ‘types’ which together form a MLM system. These ‘types’ include the income received from downline commission based on position and the income received based on enrolling a member in the MLM, also known as sponsorship. These commission structures may be maintained after the merger for each specific MLM that was merged. This way members of the multiline MLM have access to both their original downlines and commission plan while still being able to take advantage of the features and commission plan of the multiline MLM. Members will also have access to a product tree MLM which is a separate MLM that is set up so that commissions made via the product tree MLM still are paid upline through the merged multiline MLM. The product tree MLM may be exclusive or cost-gated such that joining or continuing to be a member of the multiline MLM is incentivized by free or reduced cost access to the product tree MLM. The product tree MLM need not be controlled by the same person, persons, entity, or entities, as the multiline MLM.

### CROSS-REFERENCE TO RELATED APPLICATION

The present application claims the priority benefit of U.S. provisional application number 63/220,855 filed Jul. 12, 2021, the disclosure of which is incorporated herein by reference.

### FIELD OF THE DISCLOSURE

The present disclosure is generally related to merging multi-level marketing systems.

### BACKGROUND

MLM companies are defined by a commission structure that is multi-level, such that a commission is paid to at least one member above the member who made a sale or purchase. However, there are multiple kinds of commission structures, for example, binary, matrix, or Unilevel. The problem is that merging these companies while maintaining the integrity of the existing commission tree has been unsuccessful when the two companies do not have the same kind of commission structure. Usually when companies with a different commission structure do merge, the two commission trees are simply kept separate and retain their traits and commission rates. Therefore, members of a binary commission structure must continue to build that structure even if other members of the now merged company are Unilevel. If the merged company does decide to attempt to merge the commission trees, it often ends with members feeling disoriented by changes in position and can bring sudden changes in what was steady income which is very upsetting to members when the change results in a loss of income. *It may be necessary to entice members of the original MLMs in order to increase the amount of members retained after a merger. Otherwise, members may seek out or focus on other MLMs that are closer to their original MLM in size and/or structure. There is a need for existing MLM companies to merge without having to either continue to keep the companies separate or upset members by rearranging the existing commission structures.

### DESCRIPTIONS OF THE DRAWINGS

FIG. 1: Illustrates a Multi-Level Marketing Merger System.

FIG. 2: Illustrates a Multiline MLM Multiline User Database.

FIG. 3: Illustrates a Multiline MLM Sales Database.

FIG. 4: Illustrates a Multiline MLM Commission Module.

FIG. 5: Illustrates a Multiline MLM Commission Rules Database.

FIG. 6: Illustrates a Multiline MLM Commission Database.

FIG. 7: Illustrates a Multiline MLM Additional Line Module.

FIG. 8: Illustrates a Multiline MLM Merger Module.

FIG. 9: Illustrates a Unilevel MLM Unilevel Base Module.

FIG. 10: Illustrates a Unilevel MLM Unilevel User Database.

FIG. 11: Illustrates a Matrix MLM Matrix Base Module.

FIG. 12: Illustrates a Matrix MLM Matrix User Database.

FIG. 13: Illustrates a Binary MLM Binary Base Module.

FIG. 14: Illustrates a Binary MLM Binary User Database.

FIG. 15: Illustrates a Merged MLM User Data Collection Module.

FIG. 16: Illustrates a Merged MLM Merged User Database.

FIG. 17: Illustrates a Merged MLM Merged Sales Database.

FIG. 18: Illustrates a Merged MLM Merged Commission Module.

FIG. 19: Illustrates a Merged MLM Merged Com. Rules Database.

FIG. 20: Illustrates a Merged MLM Merged Commission Database.

FIG. 21: Illustrates a Merged MLM Merged Sign-up Module.

FIG. 22: Illustrates a Merged MLM Merged Integration Module.

FIG. 23: Illustrates a Product Tree MLM PT Sign-up Module.

FIG. 24: Illustrates a Product Tree MLM PT User Database.

FIG. 25: Illustrates a Product Tree MLM PT Sales Database.

FIG. 26: Illustrates a Product Tree MLM PT Integration Module.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

This is a system for a Multi-Level Marketing Merger System. This system comprises of a 102 Multiline MLM which is a distribution organization characterized by a multi-level payment structure where in each user of the organization is a distributor and pays commission to the user or users above them in the organization's structure, and which allows users to have an infinite amount of lines, which are users below them paying commission, and the users below those users, and so on, in an embodiment these additional lines may only be added once the users initial lines meet a threshold volume or commission amount, at element 102. A 104 Multiline MLM Multiline User Database which contains information on user's position in the 102 Multiline MLM commission structure, who enrolled or sponsored the user in the 102 Multiline MLM, and how many lines the user is currently allowed, at element 104. A 106 Multiline MLM Sales Database which contains data on sales made by users, which is used by the 108 Multiline MLM Commission Module to pay commissions to other users, at element 106. A 108 Multiline MLM Commission Module which calculates commission based on new sales data in the 106 Multiline MLM Sales Database and stores that commission in the 112 Multiline MLM Commission Database, in some embodiments the 108 Multiline MLM Commission Module may also pay users directly, at element 108. A 110 Multiline MLM Commission Rules Database which stores commission rules which are used by the 108 Multiline MLM Commission Module to determine commissions, at element 110. A 112 Multiline MLM Commission Database which stores commissions calculated by the 108 Multiline MLM Commission Module which are then used by the 114 Multiline MLM Additional Line Module to determine if the user qualifies for an additional line, in some embodiments this data may be used by another module to pay commissions to users, at element 112. A 114 Multiline MLM Additional Line Module which determines if the user has met the threshold commission value on their existing lines based on data from the 112 Multiline MLM Commission Database and if so adds an additional line to the number of lines that user is allowed, at element 114. A 116 Multiline MLM Merger Module which receives data from the 124 Unilevel MLM Unilevel User Database via the 122 Unilevel MLM Unilevel Base Module, 130 MLM Matrix User Database via the 128 Matrix MLM Matrix Base Module, and 136 Binary MLM Binary User Database via the 134 Binary MLM Binary Base Module, makes sure the data contains the relevant metrics, and sends the data to the 140 Merged MLM User Data Collection Module, at element 116. The 118 Cloud or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party 118 Clouds enable organizations to focus on their core businesses instead of expending resources on computer infrastructure and maintenance, at element 118. A number of 120 Unilevel MLMs which are distribution organizations characterized by a multi-level payment structure where in each user of the organization is a distributor and pays commission to the user or users above them in the organization's structure, and which allows users to have an infinite amount of lines, which are users below them paying commission, and the users below those users, etc. until a certain depth of users is reached, for example if user 1 is above user 2, who is above user 3, who is above user 4, who is above user 5, etc. then users 2,3, and 4 must pay commissions to user 1, but users 5, 6, 7, etc. do not pay commissions to user 1, at element 120. A 122 Unilevel MLM Unilevel Base Module which extracts data from the 124 Unilevel MLM Unilevel User Database and sends that data to the 116 Multiline MLM Merger Module to be stored in the 104 Multiline MLM Multiline User Database, at element 122. A 124 Unilevel MLM Unilevel User Database which contains information on user's position in the 120 Unilevel MLM commission structure, who enrolled or sponsored the user in the 120 Unilevel MLM, and how many lines the user currently has, at element 124. A number of 126 Matrix MLMs which are distribution organizations characterized by a multi-level payment structure where in each user of the organization is a distributor and pays commission to the user or users above them in the organization's structure, and which allows users to have an fixed amount of lines, which are users below them paying commission, and the users below those users, etc. until a certain depth of users is reached, for example if user 1 is above user 2, who is above user 3, who is above user 4, who is above user 5, etc. then users 2,3, and 4 must pay commissions to user 1, but users 5, 6, 7, etc. do not pay commissions to user 1, and user 1 may only have a limited number of users directly below them, for example, 5, at element 126. A 128 Matrix MLM Matrix Base Module which extracts data from the 130 Matrix MLM Matrix User Database and sends that data to the 116 Multiline MLM Merger Module to be stored in the 104 Multiline MLM Multiline User Database, at element 128. A 130 Matrix MLM Matrix User Database which contains information on user's position in the 126 Matrix MLM commission structure, who enrolled or sponsored the user in the 126 Matrix MLM, and how many lines the user currently has, at element 130. A number of 132 Binary MLMs which are distribution organizations characterized by a multi-level payment structure where in each user of the organization is a distributor and pays commission to the user or users above them in the organization's structure, and which allows users to have only 2 lines, which are users below them paying commission, and the users below those users, etc. for an unlimited amount of depth, at element 132. A 134 Binary MLM Binary Base Module which extracts data from the 136 Binary MLM Binary User Database and sends that data to the 116 Multiline MLM Merger Module to be stored in the 104 Multiline MLM Multiline User Database, at element 134. A 136 Binary MLM Binary User Database which contains information on user's position in the 132 Binary MLM commission structure, who enrolled or sponsored the user in the 132 Binary MLM, at element 136. A 138 Merged MLM which is a new entity created from the merger of at least two MLMs with different structures, for example a the merger of a 120 Unilevel MLM and a 132 Binary MLM, a 120 Unilevel MLM, 126 Matrix MLM, and 132 Binary MLM, or 15 126 Matrix MLMs and one 132 Binary MLM, the 138 Merged MLM receives data from the 102 Multiline MLM in order to create an organizational structure that includes the members of the MLMs that have been merged, in some embodiments the 138 Merged MLM may not exist at the same time as some of the other components of this system, in which case the data on users may be temporarily or permanently stored in a database by the 102 Multiline MLM, in some embodiments the 138 Merged MLM may be the same legal entity as one of the MLMs being merged, for example a 132 Binary MLM may acquire a 120 Unilevel MLM and convert to a multiline structure in order to absorb the members of the 120 Unilevel MLM, in which case the 132 Binary MLM and 138 Merged MLM are the same company or organization from a legal perspective, at element 138. A 140 Merged MLM User Data Collection Module which receives user data from the 116 Multiline MLM Merger Module, which is then stored in the 142 Merged MLM Merged User Database and contains data on users from the other MLMs that were merged to create the 138 Merged MLM, at element 140. A 142 Merged MLM Merged User Database which contains information on user's position in the 138 Merged MLM commission structure, who enrolled or sponsored the user in the 138 Merged MLM or one of the MLMs that was eventually merged into the 138 Merged MLM, the number of lines that user is allowed under a multiline commission structure, and the MLM ID of the user's original MLM at element 142. *A 144 Merged MLM Merged Sales Database which contains data on sales made by users, which is used by the 146 Merged MLM Merged Commission Module to pay commissions to other users, at element 144. *A 146 Merged MLM Merged Commission Module which calculates commission based on new sales data in the 144 Merged MLM Merged Sales Database and stores that commission in the 150 Merged MLM Merged Commission Database, in some embodiments the 146 Merged MLM Merged Commission Module may also pay users directly, at element 146. *A 148 Merged MLM Merged Com. Rules Database which stores commission rules which are used by the 146 Merged MLM Merged Commission Module to determine commissions, at element 148. *A 150 Merged MLM Merged Commission Database which stores commissions calculated by the 146 Merged MLM Merged Commission Module, in some embodiments this data may be used by another module to pay commissions to users, at element 150. *A 152 Merged MLM Merged Sign-up Module which enrolls users of the 138 Merged MLM in the 156 Product Tree MLM by extracting user data from the 142 Merged MLM Merged User Database and sending that data to the 158 Product Tree MLM PT Sign-up Module to be stored in the 160 Product Tree MLM PT User Database, at element 152. *A 154 Merged MLM Merged Integration Module which collects sales data from the 162 Product Tree MLM PT Sales Database via the 164 Product Tree MLM PT Integration Module and stores it in the 144 Merged MLM Merged Sales Database, at element 154. *A 156 Product Tree MLM which is an MLM of any type or structure in which each product distributed by the MLM has a unique commission tree, meaning each user may have a completely different position in the commission tree for two separate products, at element 156. *A 158 Product Tree MLM PT Sign-up Module which receives data from the 152 Merged MLM Merged Sign-up Module and stores that data in the 160 Product Tree MLM PT User Database so that members of the 138 Merged MLM are enrolled in the 156 Product Tree MLM, at element 158. *A 160 Product Tree MLM PT User Database which stores data on users that are members of the 156 Product Tree MLM, at element 160. *A 162 Product Tree MLM PT Sales Database which contains data on sales made by users of the 156 Product Tree MLM, this database includes only sales made via 156 Product Tree MLM software or other methods specific to the 156 Product Tree MLM such that sales made within another MLM's structure are not included, in another embodiment all sales made by users that are possible to track will be stored in the database, at element 162. *A 164 Product Tree MLM PT Integration Module which extracts data from the 162 Product Tree MLM PT Sales Database and sends that data to the 154 Merged MLM Merged Integration Module, at element 164.

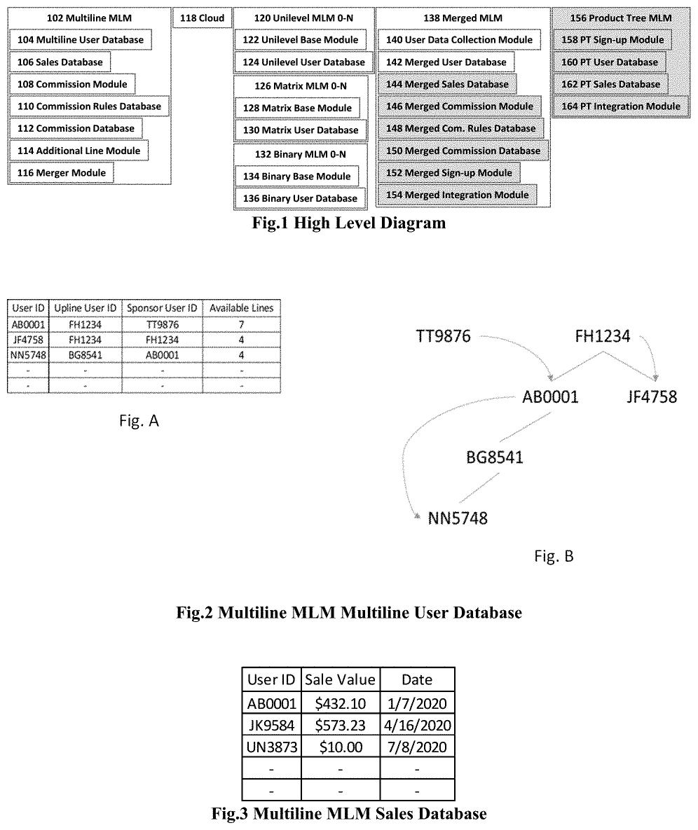

Functioning of the 104 Multiline MLM Multiline User Database will now be explained with reference to FIG. 2. The 104 Multiline MLM Multiline User Database contains a user ID, for example, AB0001, information on user's position in the 102 Multiline MLM commission structure, for example the user ID of the user above them in the commission structure, for example, FH1234, who enrolled or sponsored the user in the 102 Multiline MLM, for example, user ID TT9876, and how many lines the user is currently allowed, for example, 7, users are assigned a default number of lines when they join the 102 Multiline MLM, users that were merged from another MLM, for example, the 120 Unilevel MLM will come into the 102 Multiline MLM with at least the number of lines they had under their old MLM structure, in an embodiment the default number of lines is 4, FIG. 2B shows a possible commission structure based on the data in FIG. 2A, wherein the straight lines indicate an upline/downline relationship between two users and a curved, arrowed line indicates that the user the arrow points to was sponsored by the user the line originates from, more lines and users may exist than are shown, element 200.

Functioning of the 106 Multiline MLM Sales Database will now be explained with reference to FIG. 3. The 106 Multiline MLM Sales Database contains data on sales made by users, which includes a user ID, for example, AB0001, a sale value, for example, $432.10, and a transaction date, for example, Jan. 7, 2020, which is used by the 108 Multiline MLM Commission Module to pay commissions to other users, in some embodiments the database may include more sales data such as the seller's ID if applicable, item IDs of the items sold, volume sold, payment method and data, etc., element 300.

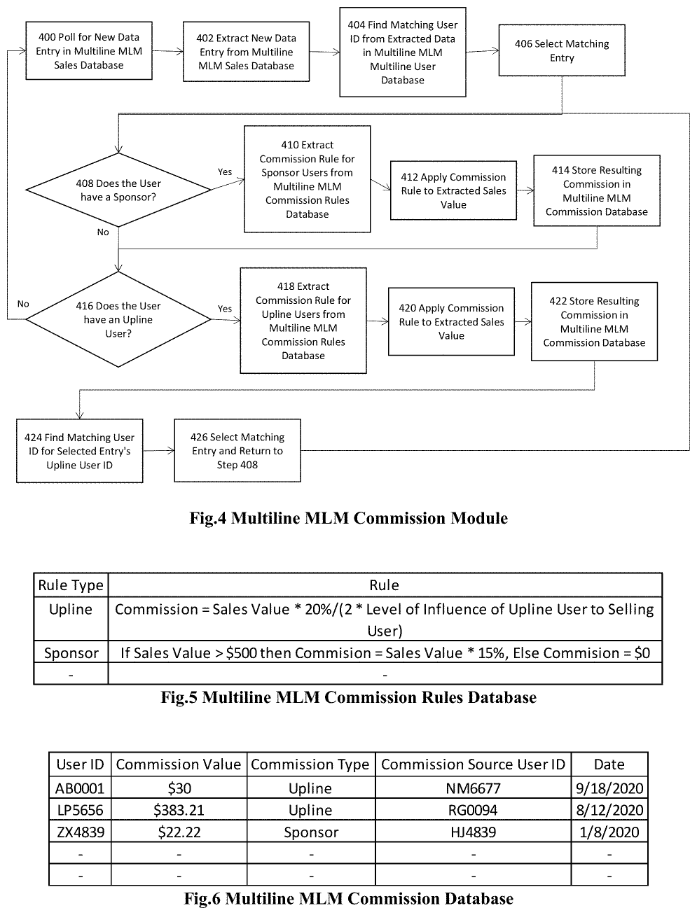

Functioning of the 108 Multiline MLM Commission Module will now be explained with reference to FIG. 4. The process begins with the 108 Multiline MLM Commission Module polling for a new data entry in the 106 Multiline MLM Sales Database, for example, when a sale is made by a user, at step 400. The 108 Multiline MLM Commission Module extracts the new data entry from the 106 Multiline MLM Sales Database which includes at least a user ID, sales value, and date, at step 402. The 108 Multiline MLM Commission Module searches for a User ID in the 104 Multiline MLM Multiline User Database that matches the user ID extracted from the 106 Multiline MLM Sales Database, for example if the extracted user ID had a value of “AB0001” then the 108 Multiline MLM Commission Module will search the 104 Multiline MLM Multiline User Database for a value of “AB0001” in the “User ID” category, at step 404. The 108 Multiline MLM Commission Module selects the entry in the 104 Multiline MLM Multiline User Database with a matching user ID value, at step 406. The 108 Multiline MLM Commission Module determines if the user has a sponsor by checking the entry for a value in the “Sponsor User ID” category, if there is no value, or the value does not correspond to a user ID then the 108 Multiline MLM Commission Module will skip to step 416, at step 408. If there is a value that corresponds to a user ID in the “Sponsor User ID” category, the 108 Multiline MLM Commission Module extracts the commission rule from the 110 Multiline MLM Commission Rule Database for sponsor users, at step 410. The 108 Multiline MLM Commission Module applies the extracted commission rule to the sales value extracted from the 106 Multiline MLM Sales Database, for example if the rule is 10% commission for sponsors and the sales value is $300, then $300 will be multiplied by 10% to get $30 which is the commission payable to the sponsor, in an embodiment the sponsor may be paid directly by the 108 Multiline MLM Commission Module after this step, at step 412. The 108 Multiline MLM Commission Module stores the resulting commission in the 112 Multiline MLM Commission Database along with the user ID of the sponsoring user to be paid, the user ID of the sponsored user, the commission type, in this case sponsor, and the date extracted from the 106 Multiline MLM Sales Database, in some embodiments the date may be changed to reflect a delay in the processing of the commission or payment of the commission, at step 414. The 108 Multiline MLM Commission Module determines if the user has an upline user by checking the entry for a value in the “Upline User ID” category, if there is no value, or the value does not correspond to a user ID then the 108 Multiline MLM Commission Module will return to polling for a new data entry in the 106 Multiline MLM Sales Database, at step 416. If there is a value that corresponds to a user ID in the “Upline User ID” category, the 108 Multiline MLM Commission Module extracts the commission rule from the 110 Multiline MLM Commission Rule Database for upline users, at step 418. The 108 Multiline MLM Commission Module applies the extracted commission rule to the sales value extracted from the 106 Multiline MLM Sales Database, for example if the rule is 10% commission for upline users and the sales value is $300, then $300 will be multiplied by 10% to get $30 which is the commission payable to the upline user, in some embodiments users may receive a different commission based on how many levels upline they are from the user who made the sale, for example, the upline user of the upline user may earn 5% commission, and next upline user may earn 1% commission, in an embodiment the upline user may be paid directly by the 108 Multiline MLM Commission Module after this step, at step 420. The 108 Multiline MLM Commission Module stores the resulting commission in the 112 Multiline MLM Commission Database along with the user ID of the upline user to be paid, the user ID of the downline user, the commission type, in this case upline, and the date extracted from the 106 Multiline MLM Sales Database, in some embodiments the date may be changed to reflect a delay in the processing of the commission or payment of the commission, at step 422. The 108 Multiline MLM Commission Module then searches the 104 Multiline MLM Multiline User Database for an entry where the user ID in the “User ID” category matches the user ID in the “Upline User ID” category of the currently selected entry. at step 424. The 108 Multiline MLM Commission Module selects the entry with the matching user ID value as the new selected entry and returns to step 408, at step 426.

Functioning of the 110 Multiline MLM Commission Rules Database will now be explained with reference to FIG. 5. The 110 Multiline MLM Commission Rules Database contains commission rules which are used by the 108 Multiline MLM Commission Module to determine commissions, commission rules can be complex or simple but will often involve a mathematical calculation, for example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc., in another example the rule may dictate that the commission for sponsors is 15% of the sale but only if the sale is over $500, otherwise no commission is paid, the database also contains the type of rule, for example, “Sponsor” which indicates that the rule should be used to calculate commissions for sponsors, in some embodiments multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale, element 500.

Functioning of the 112 Multiline MLM Commission Database will now be explained with reference to FIG. 6. The 112 Multiline MLM Commission Database contains commissions calculated by the 108 Multiline MLM Commission Module which are then used by the 114 Multiline MLM Additional Line Module to determine if the user qualifies for an additional line, in some embodiments this data may be used by another module to pay commissions to users, which comprises at least a user ID, for example, AB0001, a commission value, for example, $30, the type of commission, for example, downline, the user ID of the user the commission came from, for example, NM6677, and a date, for example, Sep. 18, 2020, if the commission came from a sale made somewhere in a user's downline then the commission will be considered to come from the immediately downline user, in other embodiments the commission may be recorded as coming from the selling user, element 600.

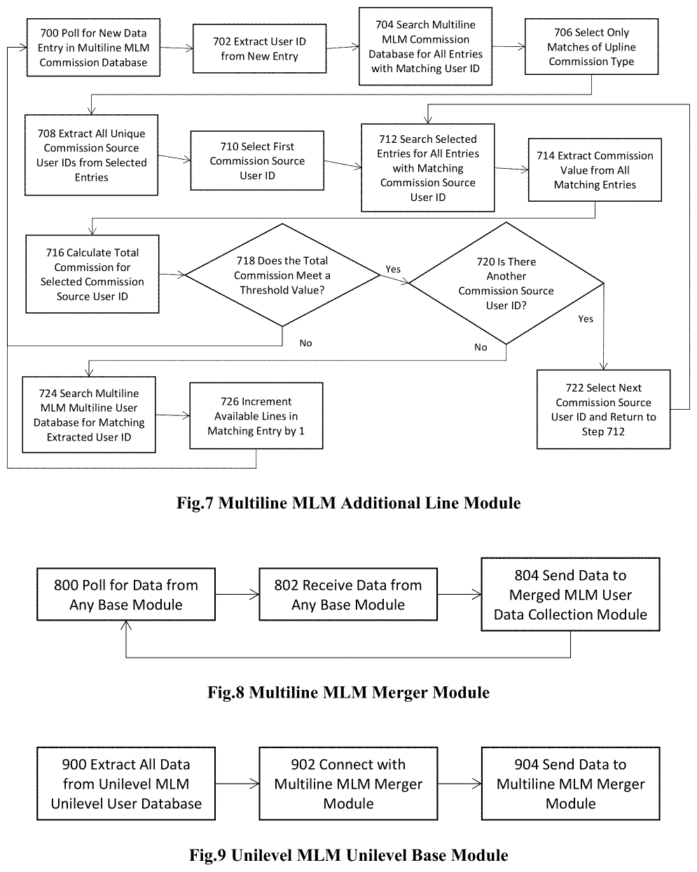

Functioning of the 114 Multiline MLM Additional Line Module will now be explained with reference to FIG. 7. The process begins with the 114 Multiline MLM Additional Line Module polling for a new data entry in the 112 Multiline MLM Commission Database, at step 700. The 114 Multiline MLM Additional Line Module extracts the user ID from the User ID category in the new data entry, for example, AB0001, at step 702. The 114 Multiline MLM Additional Line Module searches the 112 Multiline MLM Commission Database for all entries that also have the extracted user ID in the User ID category, which is data on all the commissions that have been paid to that user, at step 704. The 114 Multiline MLM Additional Line Module selects all the matching entries that also have “upline” in the Commission Type category, at step 706. The 114 Multiline MLM Additional Line Module extracts all the user IDs in the Commission Source User ID category of the entries, ignoring repeats, each of these user IDs corresponds to a user that is directly downline of the user who's user ID was extracted from the new data entry, and therefore each correspond to a line, in some embodiments, lines that have not yet made sales may be accounted for by creating a null or nominal commission upon creation, for example, if user AB0001 places user CD0002 in their immediate downline a record may be recorded in the 112 Multiline MLM Commission Database for $0.01 or $0.00 so that CD0002 is recognized as the start of one of AB0001's downlines, at step 708. The 114 Multiline MLM Additional Line Module selects the first of the extracted Commission Source User IDs, first may be determined by, for example, alphabetical order or most recent commission, at step 710. The 114 Multiline MLM Additional Line Module searches the entries selected in step 706 for all entries that match the commission source user ID selected in the Commission Source User ID category, which will find all the entries that correspond to commissions made by a single line, at step 712. The 114 Multiline MLM Additional Line Module extracts the commission value in the Commission Value Category for each matching entry, in some embodiments the commissions are further filtered by a time frame, for example, only commission values from commissions made in the last month will be extracted, at step 714. The 114 Multiline MLM Additional Line Module totals the extracted commission values by adding them all together to get the total commission from that line, at step 716. The 114 Multiline MLM Additional Line Module determines if the total commission calculated meets a threshold value, the threshold value is a value that all lines must meet before a user is allowed to have a new line, for example if the user has 7 lines, each line has made over $1000 in commission, and the threshold value is $1000 then the user will be allowed to create and 8th line, the threshold value can be fixed or variable, in an embodiments the threshold value is stored in a database and retrieved by the 114 Multiline MLM Additional Line Module, if the total commission calculated fails to meet the threshold value then the user cannot receive a new line because all lines must meet the threshold value and the 114 Multiline MLM Additional Line Module will return to polling for a new data entry in the 112 Multiline MLM Commission Database, at step 718. If the total commission calculated meets the threshold value, the 114 Multiline MLM Additional Line Module determines if there is another commission source user ID that was extracted in step 708, at step 720. If there is another commission source user ID, the 114 Multiline MLM Additional Line Module selects the next commission source user ID and returns to step 712, at step 722. If there is not another commission source user ID, the 114 Multiline MLM Additional Line Module searches the 104 Multiline MLM Multiline User Database for an entry that matches the user ID extracted from the new entry in step 702 in the User ID category, at step 724. The 114 Multiline MLM Additional Line Module increments the number in the Available Lines category of the matching entry by 1, which allows the user to create one additional line, in some embodiments the number in the Available Lines category of the matching entry may be changed in another way, for example, increased by 2, multiplied by 1.2 and rounded to the nearest whole number, squared, etc., at step 726.

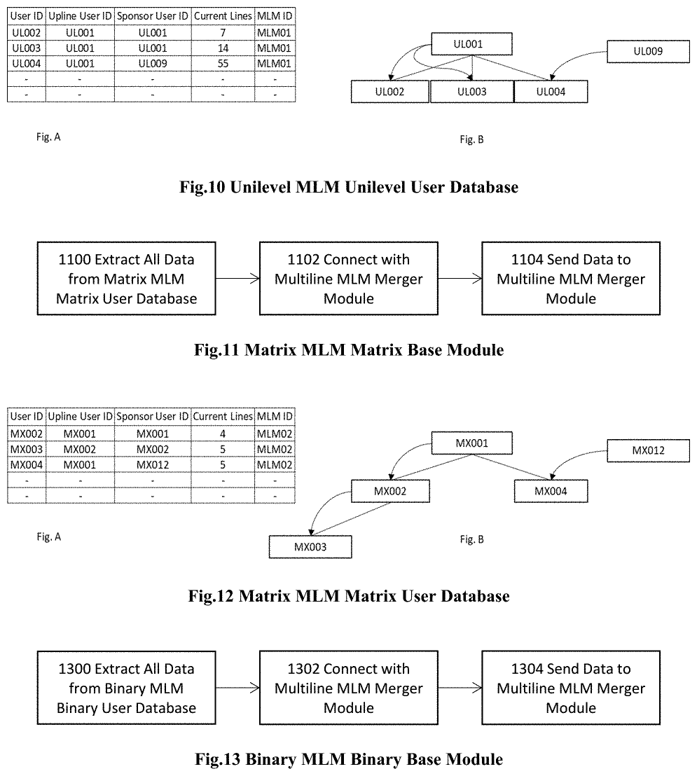

Functioning of the 116 Multiline MLM Merger Module will now be explained with reference to FIG. 8. The process begins with the 116 Multiline MLM Merger Module polling for data from the 122 Unilevel MLM Unilevel Base Module, 128 Matrix MLM Matrix Base Module, or 134 Binary MLM Binary Base Module. This data is extracted by the Base Module of each type of MLM from the respective database of user data, at step 800. *The 116 Multiline MLM Merger Module receives data from the 122 Unilevel MLM Unilevel Base Module, 128 Matrix MLM Matrix Base Module, or 134 Binary MLM Binary Base Module which includes a user ID, for example, UL002, information on user's position in their original MLM commission structure via the user ID of the user above them in the commission structure, for example, UL001, who enrolled or sponsored the user in their original MLM, for example, user ID UL001, how many lines the user currently has in their original MLM, for example, 7, and the MLM ID of the MLM the data is coming from, for example MLM01, in some embodiments where the number of lines is restricted then the number of lines may not be included with each user but sent as one value, for example a 134 Binary MLM may be assumed to allow 2 lines for each user, and a 126 Matrix MLM may have a known maximum number of lines, for example 5, which is already accounted for by the system or sent to the 116 Multiline MLM Merger Module alongside the user data, at step 802. The 116 Multiline MLM Merger Module sends the data to the 140 Merged MLM User Data Collection Module to be stored in the 142 Merged MLM Merged User Database, in an embodiment user data without a number of lines will be set to the default value, for example data from a 132 Binary MLM may not contain data for the amount of lines because all members of a 132 Binary MLM have 2 available lines, in which case the data will be amended to include the default number of lines that would be assigned to a new member of the 138 Merged MLM, in an embodiment if the number of lines a user has is less than the default value it will be set to the default value, in an embodiment the default value is 4 lines, at step 804.

Functioning of the 122 Unilevel MLM Unilevel Base Module will now be explained with reference to FIG. 9. The process begins with the 122 Unilevel MLM Unilevel Base Module extracts all the data stored in the 124 Unilevel MLM Unilevel User Database, at step 900. The 122 Unilevel MLM Unilevel Base Module connects with the 116 Multiline MLM Merger Module through the 118 Cloud or Internet, via a physical connection, or by any other method of transferring data, at step 902. The 122 Unilevel MLM Unilevel Base Module sends the data extracted from the 124 Unilevel MLM Unilevel User Database to the 116 Multiline MLM Merger Module, at step 904.

Functioning of the 124 Unilevel MLM Unilevel User Database will now be explained with reference to FIG. 10. *The 124 Unilevel MLM Unilevel User Database contains information on user's position in the 120 Unilevel MLM commission structure, who enrolled or sponsored the user in the 120 Unilevel MLM, and how many lines the user currently has, which includes a user ID, for example, UL002, information on user's position in the 120 Unilevel MLM commission structure, for example the user ID of the user above them in the commission structure, for example, UL001, who enrolled or sponsored the user in the 120 Unilevel MLM, for example, user ID UL009, and how many lines the user currently has within the existing 120 Unilevel MLM, for example, 7, and the MLM ID of the MLM, for example, MLM01, FIG. 10B shows a possible commission structure based on the data in FIG. 10A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown, element 1000.

Functioning of the 128 Matrix MLM Matrix Base Module will now be explained with reference to FIG. 11. The process begins with the 128 Matrix MLM Matrix Base Module extracts all the data stored in the 130 Matrix MLM Matrix User Database, at step 1100. The 128 Matrix MLM Matrix Base Module connects with the 116 Multiline MLM Merger Module through the 118 Cloud or Internet, via a physical connection, or by any other method of transferring data, at step 1102. The 128 Matrix MLM Matrix Base Module sends the data extracted from the 130 Matrix MLM Matrix User Database to the 116 Multiline MLM Merger Module, at step 1104.

Functioning of the 130 Matrix MLM Matrix User Database will now be explained with reference to FIG. 12. *The 130 Matrix MLM Matrix User Database contains information on user's position in the 126 Matrix MLM commission structure, who enrolled or sponsored the user in the 126 Matrix MLM, and how many lines the user currently has, which includes a user ID, for example, MX002, information on user's position in the 126 Matrix MLM commission structure, for example the user ID of the user above them in the commission structure, for example, MX001, who enrolled or sponsored the user in the 126 Matrix MLM, for example, user ID MX001, how many lines the user currently has within the existing 126 Matrix MLM, for example, 5, and the MLM ID of the MLM, for example, MLM02, in an embodiment the number of lines a user currently has may not be necessary as all users under a 126 Matrix MLM can be assumed to have the maximum allowed for that structure, for example in a 126 Matrix MLM where the maximum amount of lines is 5, all users will be given a default 5 lines after being merged into the 102 Multiline MLM, FIG. 12B shows a possible commission structure based on the data in FIG. 12A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown, element 1200.

Functioning of the 134 Binary MLM Binary Base Module will now be explained with reference to FIG. 13. The process begins with the 134 Binary MLM Binary Base Module extracts all the data stored in the 136 Binary MLM Binary User Database, at step 1300. The 134 Binary MLM Binary Base Module connects with the 116 Multiline MLM Merger Module through the 118 Cloud or Internet, via a physical connection, or by any other method of transferring data, at step 1302. The 134 Binary MLM Binary Base Module sends the data extracted from the 136 Binary MLM Binary User Database to the 116 Multiline MLM Merger Module, at step 1304.

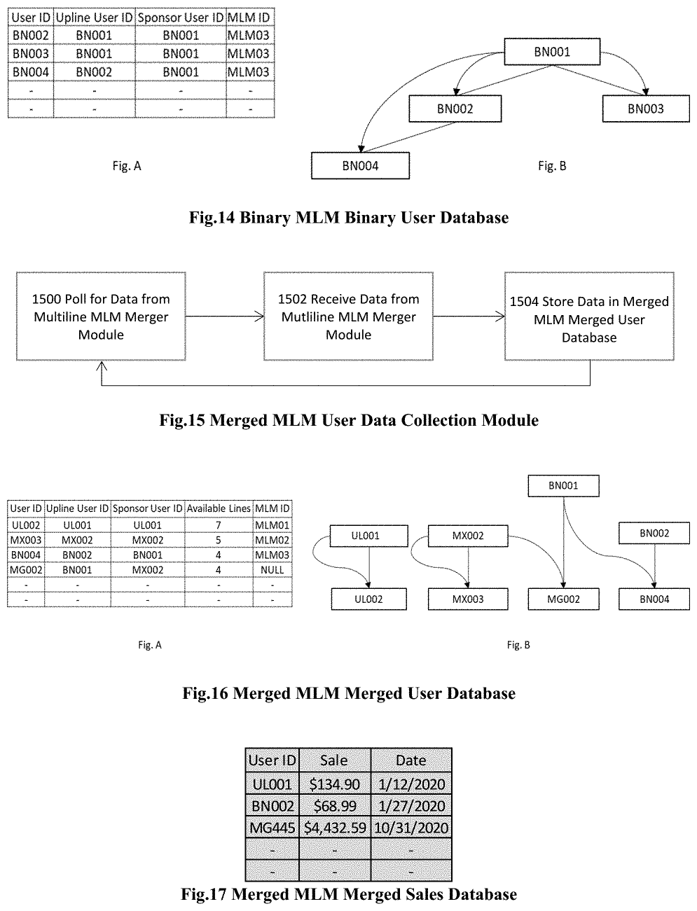

Functioning of the 136 Binary MLM Binary User Database will now be explained with reference to FIG. 14. *The 136 Binary MLM Binary User Database contains information on user's position in the 132 Binary MLM commission structure, who enrolled or sponsored the user in the 132 Binary MLM, and how many lines the user currently has, which includes a user ID, for example, BN002, information on user's position in the 132 Binary MLM commission structure, for example the user ID of the user above them in the commission structure, for example, BN001, who enrolled or sponsored the user in the 132 Binary, for example, user ID BN001, and the MLM ID of the MLM, for example, MLM03, FIG. 14B shows a possible commission structure based on the data in FIG. 14A, wherein the straight lines indicate an upline/downline relationship between two users and a curved, arrowed line indicates that the user the arrow points to was sponsored by the user the line originates from, and the dotted straight line indicates the two users have an indirect upline/downline relationship, meaning there are more users in the line that are not shown, more lines and users may exist than are shown, element 1400.

Functioning of the 140 Merged MLM User Data Collection Module will now be explained with reference to FIG. 15. The process begins with the 140 Merged MLM User Data Collection Module polling for data from the 116 Multiline MLM Merger Module, at step 1500. The 140 Merged MLM User Data Collection Module receives data from the 116 Multiline MLM Merger Module, at step 1502. The 140 Merged MLM User Data Collection Module stores the received data in the 142 Merged MLM Merged User Database, at step 1504.

Functioning of the 142 Merged MLM Merged User Database will now be explained with reference to FIG. 16. *The 142 Merged MLM Merged User Database contains a user ID, for example, UL002, information on user's position in the 138 Merged MLM commission structure, for example the user ID of the user above them in the commission structure, for example, UL001, who enrolled or sponsored the user in the 138 Merged MLM or the original MLM that was merged into the 138 Merged MLM, for example, user ID UL001, how many lines the user is currently allowed, for example, 7, and the MLM ID of the user's original MLM, for example, MLM01, users who joined the 138 Merged MLM direct do not have an MLM ID, in an embodiment the 138 Merged MLM may have its own MLM ID, for example, MLMOO, users are assigned a default number of lines when they join the 138 Merged MLM, users that were merged from another MLM, for example, the 120 Unilevel MLM will come into the 138 Merged MLM with at least the number of lines they had under their old MLM structure, in an embodiment the default number of lines is 4, FIG. 16B shows a possible commission structure based on the data in FIG. 16A, wherein the straight lines indicate an upline/downline relationship between two users and a curved, arrowed line indicates that the user the arrow points to was sponsored by the user the line originates from, more lines and users may exist than are shown, element 1600.

Functioning of the 144 Merged MLM Merged Sales Database will now be explained with reference to FIG. 17. *The 144 Merged MLM Merged Sales Database contains data on sales made by users, which includes a user ID, for example, UL001, a sale value, for example, $134.90, and a transaction date, for example, Jan. 12, 2020, which is used by the 146 Merged MLM Merged Commission Module to pay commissions to other users, in some embodiments the database may include more sales data such as the seller's ID if applicable, item IDs of the items sold, volume sold, payment method and data, etc., and may contain sales data from before the merger if the data is available, element 1700.

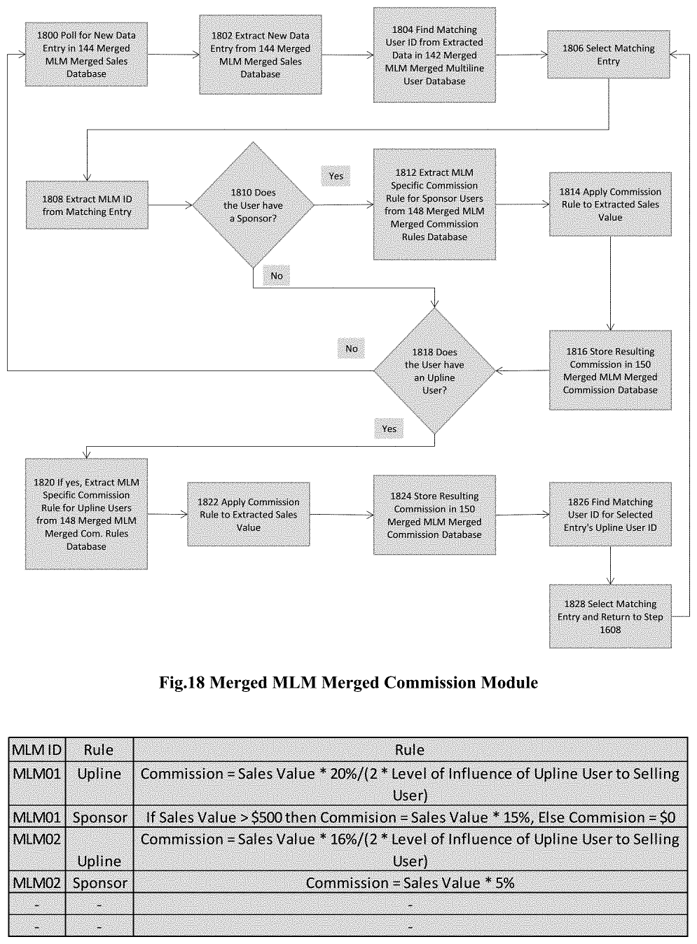

Functioning of the 146 Merged MLM Merged Commission Module will now be explained with reference to FIG. 18. The process begins with *the 146 Merged MLM Merged Commission Module polling for a new data entry in the 144 Merged MLM Merged Sales Database, for example, when a sale is made by a user, at step 1800. *The 146 Merged MLM Merged Commission Module extracts the new data entry from the 144 Merged MLM Merged Sales Database which includes at least a user ID, sales value, and date, at step 1802. *The 146 Merged MLM Merged Commission Module searches for a User ID in the 142 Merged MLM Merged User Database that matches the user ID extracted from the 144 Merged MLM Merged Sales Database, for example if the extracted user ID had a value of “UL002” then the 146 Merged MLM Merged Commission Module will search the 142 Merged MLM Merged User Database for a value of “UL002” in the “User ID” category, at step 1804. *The 146 Merged MLM Merged Commission Module selects the entry in the 142 Merged MLM Merged User Database with a matching user ID value, at step 1806. *The 146 Merged MLM Merged Commission Module extracts the MLM ID of the selected entry in the 142 Merged MLM Merged User Database, at step 1808. *The 146 Merged MLM Merged Commission Module determines if the user has a sponsor by checking the entry for a value in the “Sponsor User ID” category, if there is no value, or the value does not correspond to a user ID then the 146 Merged MLM Merged Commission Module will skip to step 1816, at step 1810. *If there is a value that corresponds to a user ID in the “Sponsor User ID” category, the 146 Merged MLM Merged Commission Module extracts the commission rule from the 148 Merged MLM Merged Com. Rules Database for sponsor users that matches the extracted MLM ID, at step 1812. *The 146 Merged MLM Merged Commission Module applies the extracted commission rule to the sales value extracted from the 144 Merged MLM Merged Sales Database, for example if the rule is 10% commission for sponsors and the sales value is $300, then $300 will be multiplied by 10% to get $30 which is the commission payable to the sponsor, in an embodiment the sponsor may be paid directly by the 146 Merged MLM Merged Commission Module after this step, at step 1814. *The 146 Merged MLM Merged Commission Module stores the resulting commission in the 150 Merged MLM Merged Commission Database along with the user ID of the sponsoring user to be paid, the user ID of the sponsored user, the commission type, in this case sponsor, and the date extracted from the 144 Merged MLM Merged Sales Database, in some embodiments the date may be changed to reflect a delay in the processing of the commission or payment of the commission, at step 1816. *The 146 Merged MLM Merged Commission Module determines if the user has an upline user by checking the entry for a value in the “Upline User ID” category, if there is no value, or the value does not correspond to a user ID then the 146 Merged MLM Merged Commission Module will return to polling for a new data entry in the 144 Merged MLM Merged Sales Database, at step 1818. *If there is a value that corresponds to a user ID in the “Upline User ID” category, the 146 Merged MLM Merged Commission Module extracts the commission rule from the 148 Merged MLM Merged Com. Rules Database for upline users that matches the extracted MLM ID, at step 1820. *The 146 Merged MLM Merged Commission Module applies the extracted commission rule to the sales value extracted from the 144 Merged MLM Merged Sales Database, for example if the rule is 10% commission for upline users and the sales value is $300, then $300 will be multiplied by 10% to get $30 which is the commission payable to the upline user, in some embodiments users may receive a different commission based on how many levels upline they are from the user who made the sale, for example, the upline user of the upline user may earn 5% commission, and next upline user may earn 1% commission, in an embodiment the upline user may be paid directly by the 146 Merged MLM Merged Commission Module after this step, at step 1822. *The 146 Merged MLM Merged Commission Module stores the resulting commission in the 150 Merged MLM Merged Commission Database along with the user ID of the upline user to be paid, the user ID of the downline user, the commission type, in this case upline, and the date extracted from the 144 Merged MLM Merged Sales Database, in some embodiments the date may be changed to reflect a delay in the processing of the commission or payment of the commission, at step 1824. *The 146 Merged MLM Merged Commission Module then searches the 142 Merged MLM Merged Multiline User Database for an entry where the user ID in the “User ID” category matches the user ID in the “Upline User ID” category of the currently selected entry. at step 1826. *The 146 Merged MLM Merged Commission Module selects the entry with the matching user ID value as the new selected entry and returns to step 1808, at step 1828.

Functioning of the 148 Merged MLM Merged Com. Rules Database will now be explained with reference to FIG. 19. *The 148 Merged MLM Merged Com. Rules Database contains commission rules which are used by the 146 Merged MLM Merged Commission Module to determine commissions, commission rules can be complex or simple but will often involve a mathematical calculation, for example, a rule may dictate that commissions for upline users are 10% of the sales value, divided by two for each level above the selling user, meaning that for a $100 dollar sale the upline user will receive $10 the user above them, or 2nd level of influence from the user who made the sale, will receive $5, the user above them will receive $2.50, etc., in another example the rule may dictate that the commission for sponsors is 15% of the sale but only if the sale is over $500, otherwise no commission is paid, the database also contains the type of rule, for example, “Sponsor” which indicates that the rule should be used to calculate commissions for sponsors, rules are specific to the MLM ID so that users may keep a commission plan that is similar or the same as their original MLM, in some embodiments a default rule captures all users who do not have an MLM ID, in some embodiments multiple rules may exist for one rule type, for example, one rule may apply to sponsors that are also somewhere upline of the user who made the sale, while a different sponsor rule may apply if the sponsor is cross-line, meaning they are not anywhere upline of the user who made the sale, element 1900.

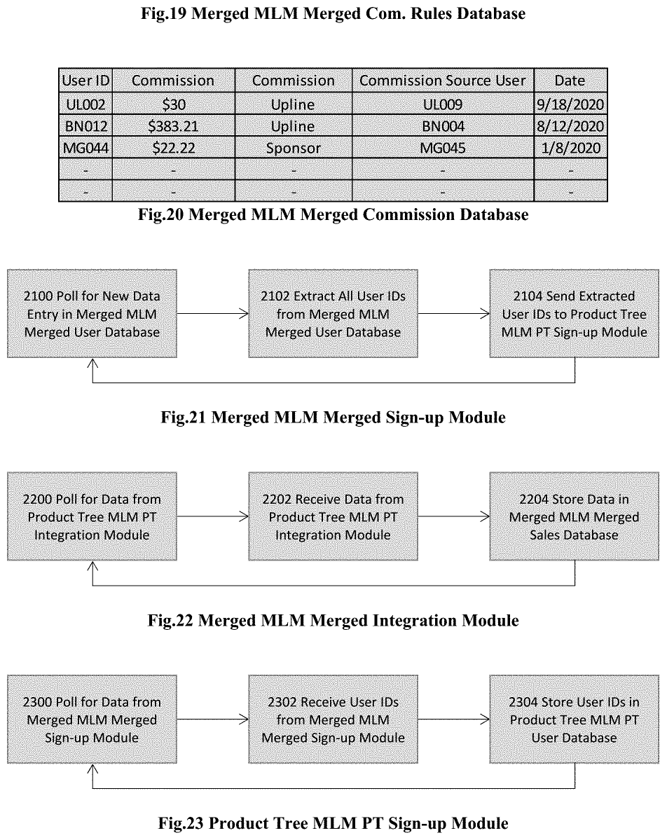

Functioning of the 150 Merged MLM Merged Commission Database will now be explained with reference to FIG. 20. *The 150 Merged MLM Merged Commission Database contains commissions calculated by the 146 Merged MLM Merged Commission Module, in some embodiments this data may be used by another module to pay commissions to users, which comprises at least a user ID, for example, UL001, a commission value, for example, $30, the type of commission, for example, downline, the user ID of the user the commission came from, for example, UL009, and a date, for example, Sep. 18, 2020, if the commission came from a sale made somewhere in a user's downline then the commission will be considered to come from the immediately downline user, in other embodiments the commission may be recorded as coming from the selling user, element 2000.

Functioning of the 152 Merged MLM Merged Sign-up Module will now be explained with reference to FIG. 21. The process begins with *the 152 Merged MLM Merged Sign-up Module polling for a new data entry in the 142 Merged MLM Merged User Database, at step 2100. *The 152 Merged MLM Merged Sign-up Module extracts all the user IDs in the “User ID” category of the 142 Merged MLM Merged User Database, in some embodiments other data may also be extracted, at step 2102. *The 152 Merged MLM Merged Sign-up Module sends the extracted user IDs to the 158 Product Tree MLM PT Sign-up Module, at step 2104.

Functioning of the 154 Merged MLM Merged Integration Module will now be explained with reference to FIG. 22. The process begins with *The 154 Merged MLM Merged Integration Module polling for data from the 164 Product Tree MLM PT Integration Module, at step 2200. *The 154 Merged MLM Merged Integration Module receives the data sent by the 164 Product Tree MLM PT Integration Module, at step 2202. *The 154 Merged MLM Merged Integration Module stores the received data as an entry in the 144 Merged MLM Merged Sales Database, in an embodiment the data may be stored with a tag that identifies the sale as made through the 156 Product Tree MLM, which may then have a different commission rule applied to it than a sale made through other means, at step 2204.

Functioning of the 158 Product Tree MLM PT Sign-up Module will now be explained with reference to FIG. 23. The process begins with *the 158 Product Tree MLM PT Sign-up Module polling for data sent by the 152 Merged MLM Merged Sign-up Module, at step 2300. *The 158 Product Tree MLM PT Sign-up Module receives the data from the 152 Merged MLM Merged Sign-up Module which contains at least one user ID, in some embodiments the data may contain additional parameters, at step 2302. *The 158 Product Tree MLM PT Sign-up Module stores the user IDs in the 160 Product Tree MLM PT User Database, if a user ID is already in the database then it may be ignored or overwritten, at step 2304.

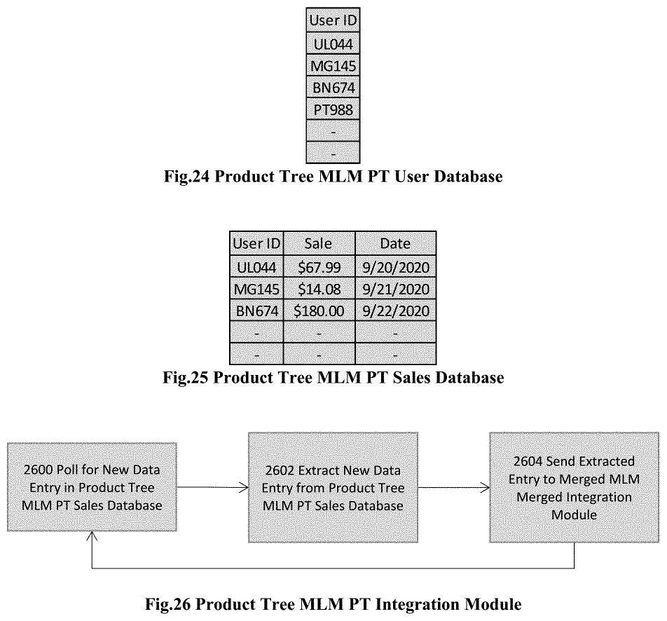

Functioning of the 160 Product Tree MLM PT User Database will now be explained with reference to FIG. 24. *The 160 Product Tree MLM PT User Database contains data on users that are members of the 156 Product Tree MLM, including at least a user ID, for example UL044, in an embodiment the 160 Product Tree MLM PT User Database may also contain user IDs for both members integrated from the 138 Merged MLM and members of the 156 Product Tree MLM only, in an embodiment users may have a separate user ID for the 156 Product Tree MLM and the 138 Merged MLM which would both be stored in the 160 Product Tree MLM PT User Database, and associated so that any one user ID could be used to find the other, element 2400.

Functioning of the 162 Product Tree MLM PT Sales Database will now be explained with reference to FIG. 25. *The 162 Product Tree MLM PT Sales Database contains data on sales made by users of the 156 Product Tree MLM including a user ID, for example UL044, a sales value, for example, $67.99, and a date the sale occurred, for example, Sep. 20, 2020, this database includes only sales made via 156 Product Tree MLM software or other methods specific to the 156 Product Tree MLM such that sales made within another MLM's structure are not included, in another embodiment all sales made by users that are possible to track will be stored in the database, element 2500.

Functioning of the 164 Product Tree MLM PT Integration Module will now be explained with reference to FIG. 26. The process begins with *the 164 Product Tree MLM PT Integration Module polling for a new data entry in the 162 Product Tree MLM PT Sales Database, at step 2600. *The 164 Product Tree MLM PT Integration Module extracts the new data entry from 162 Product Tree MLM PT Sales Database, at step 2602. *The 164 Product Tree MLM PT Integration Module sends the extracted entry to the 154 Merged MLM Merged Integration Module, at step 2604.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A method for merging at least two MLMs into a multiline MLM comprising:
providing at least a first MLM with a first set of lines, and
providing at least a second MLM with a second set of lines, and
*providing at least one product tree MLM
*providing data for at least one member of at least the first MLM and second MLM which contains at least the member's position in the commission structure of the respective MLM, and
allowing the data to be used to create a new merged MLM with a commission structure that includes at least one member of each MLM, and
*wherein the at least one member of the first MLM and second MLM maintains their downlines after being integrated into the merged MLM, and
*wherein the at least one member of the first MLM and second MLM may be allowed additional lines, and
*wherein the at least one member of the first MLM and second MLM can become members of a product tree MLM, and
*wherein at least one commission is paid in the new merged MLM for at least one sale made via the product tree MLM.
